(19) United States
(12) Patent Application Publication
(10) Pub. No.: US 2014/0378089 A1
(43) Pub. Date: Dec. 25, 2014

(54) WIRELESS MOBILE EMERGENCY SYSTEM

(71) Applicant: Serge V. Monros, Costa Mesa, CA (US)

(72) Inventor: Serge V. Monros, Costa Mesa, CA (US)

(21) Appl. No.: 14/308,134

(22) Filed: Jun. 18, 2014

Related U.S. Application Data
(60) Provisional application No. 61/838,543, filed on Jun. 24, 2013.

(51) Int. Cl. H04W 4/22

(52) U.S. Cl. CPC H04W 4/22
USPC 455/404.2; 455/404.1

(57) ABSTRACT

A wireless mobile emergency system includes a mobile user device, a cellular phone, and a communication network. The mobile user device and cellular phone are wirelessly connected through radio frequency, Wi-Fi, or Bluetooth systems. The cellular phone is connected to a communication network such as a cellular or Wi-Fi network. Depressing a button on the mobile user device activates the cell phone to automatically call preprogrammed numbers, i.e., emergency services, non-emergency services, family members. Preferably, the device is programmed to bypass password protection or other security features on the cell phone.

### RELATED APPLICATION

This application claims the benefit of U.S. Provisional Application No. 61/838,543, filed on Jun. 24, 2013.

### BACKGROUND OF THE INVENTION

The present invention is directed to a mobile emergency system wherein a user can more easily contact emergency services in the event of a disabling medical injury or similar event. More particularly, the inventive system is directed to a device worn on a user's body that interacts directly with a smart phone or similar cellular device to facilitate contact with emergency services from nearly any location.

Prior art emergency systems generally consist of multiple components that do not easily lend themselves to a mobile lifestyle. More often than not, such systems comprise a necklace or other device to be carried around by the user, which works in conjunction with a base unit connected to a land line phone system or other dial tone type phone. In this instance, such system is limited in its operation to only those times when the user device is within a certain distance of the base unit which is itself fixed to a phone jack or other land line system.

Another such system includes a user device, a mobile base unit and a cellular phone device that works in conjunction with the mobile base unit to provide telephone connectivity. Restraints on such system include the requirement of being within a predetermined distance of the mobile base unit with the user device. The base unit typically comes with a monthly service/access fee that one would be required to pay in addition to any cellular phone service. In addition, a user is required to carry the user device, the mobile base unit, and the cell phone with which the mobile base unit interacts.

Accordingly, there is a need for a wireless mobile emergency system that is more easily mobile as opposed to being connected to a land phone line. In addition, there is a need for a wireless mobile emergency system that is more easily transportable by its user rather than having many devices to carry. The present invention addresses these needs and provides other related advantages.

### SUMMARY OF THE INVENTION

The present invention is directed to a wireless mobile emergency system configured to operate with a cellular device wirelessly connected to a communication network. The system comprises a mobile user alert device having an activation button configured to establish a wireless connection with the cellular device when the activation button is depressed. The mobile user alert device is programmed activate the cellular device to establish a telephone connection with an emergency contact through the communication network when the activation button is depressed. The mobile user alert device has a microphone and speaker configured to receive and broadcast voice components of the telephone connection with the emergency contact.

The cellular device may comprise a basic cell phone, a feature phone, or a smartphone. The communication network may comprise a cellular network or a Wi-Fi network. The mobile user alert device may comprise a necklace, a bracelet, a belt buckle, a ring, a piece of jewelry, or a phone case. The wireless connection between the mobile user alert device and the cellular device is preferably radio frequency, Wi-Fi, or Bluetooth.

The mobile user alert device is programmed to activate the cellular device to establish a telephone connection with at least one of a plurality of emergency contacts depending upon a number of times or a duration of time that the activation button is depressed. By way of example, the plurality of emergency contacts may include: emergency services if the activation button is depressed once or for one second; an emergency contact or family member if the activation button is depressed twice or for three seconds; and a non-emergency provider if the activation button is depressed thrice or for five seconds. The mobile user alert device is preferably configured to issue an audible alert corresponding to the number of times or the duration of time that the activation button is depressed.

The cellular device preferably comprises a smartphone and the system further comprises a software application on the smartphone. The software application may be programmable with phone numbers for each of the plurality of emergency contacts. The software application may also be programmable with medical information of a user and be configured to transmit the medical information to at least one of the plurality of emergency contacts.

The mobile user alert device is preferably a bracelet including sensors configured to measure vital statistics of the user in real-time and the software application is configured to add the vital statistics to the medical information. The system is preferably configured to automatically establish a telephone connection with emergency services if the vital statistics exceed preset thresholds in the software application. The software application may also be configured to access GPS geo-location services on the smartphone and automatically transmit a location of the user to emergency services.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 schematically illustrates a first embodiment of the wireless mobile emergency system of the present invention;

FIG. 2 schematically illustrates a second embodiment of the wireless mobile emergency system of the present invention;

FIG. 3A illustrates an embodiment of the mobile user alert device of the present invention;

FIG. 3B illustrates another embodiment of the mobile user alert device of the present invention; and

FIG. 3C illustrates yet another embodiment of the mobile user alert device of the present invention.

### DETAILED DESCRIPTION OF THE PREFERRED EMBODIMENTS

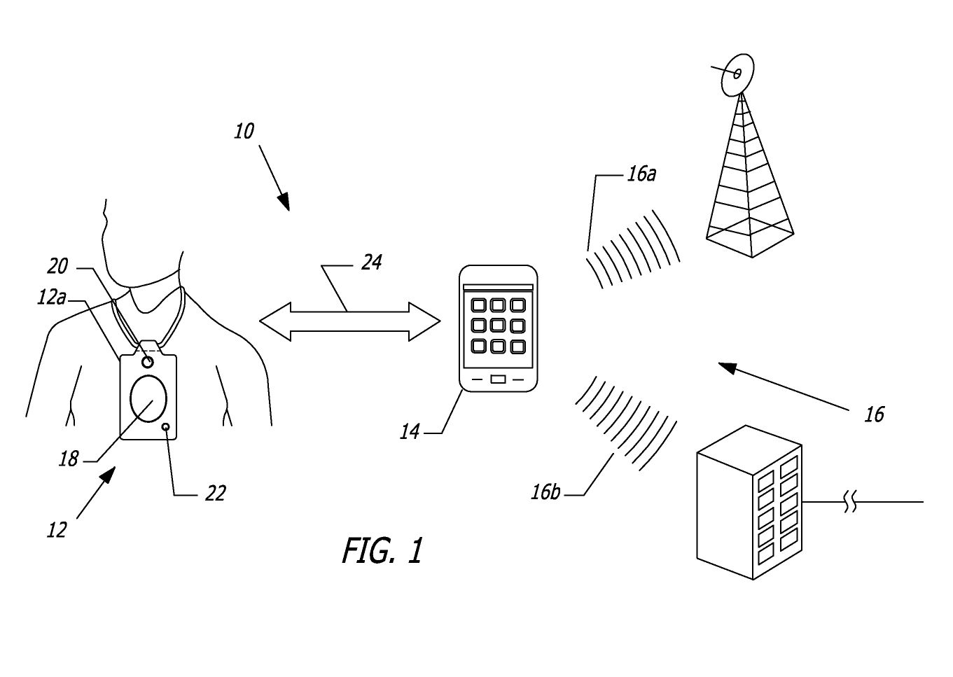

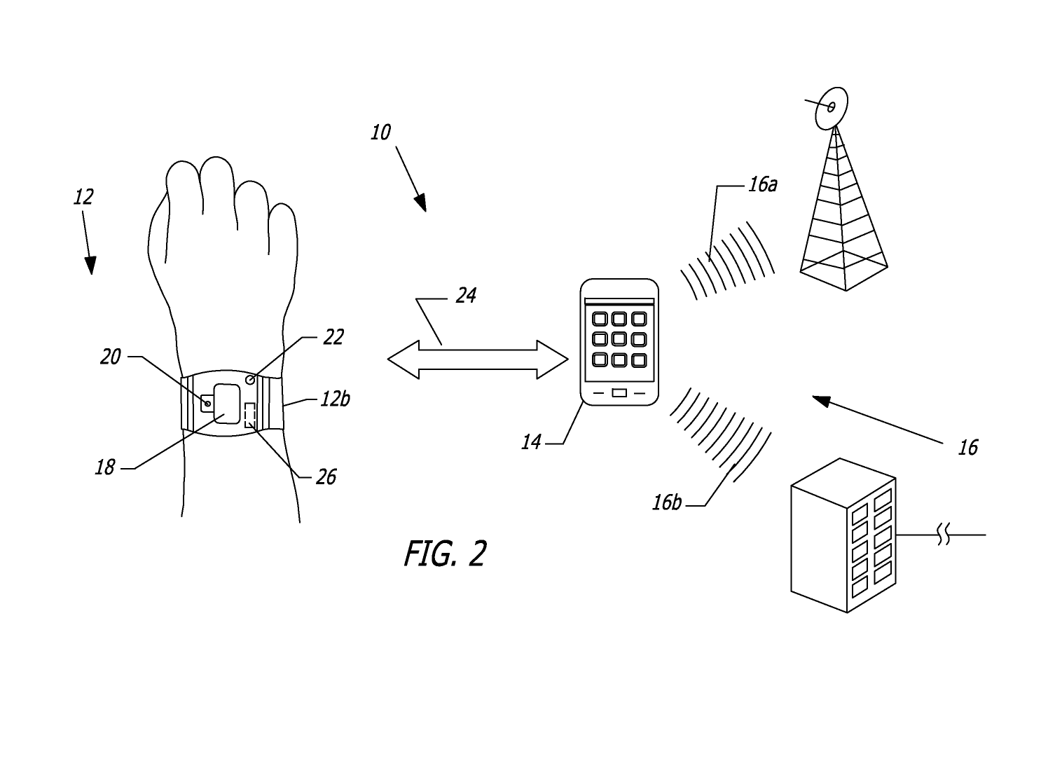

FIGS. 1 and 2 illustrate the wireless mobile emergency system, generally referred to by reference numeral 10, of the present invention. The system 10 generally includes a mobile user device 12 that interacts with a cellular phone 14, which in turn connects to a communication network 16. The mobile user device 12 may comprise a necklace 12a or a bracelet 12b configured to be worn by a user. The mobile user device 12 may also comprise any type of mobile unit that is easily carried by a user.

The cellular phone 14 may comprise any type of known cellular phone device on the market. Preferably, the phone 14 comprises a smart phone built on a mobile operating system having advanced computing capability and connectivity. However, the system 10 may also work with a basic cellular phone or a feature phone. Preferably, the phone 14 has dual connectivity capabilities to a communication network 16 comprising either a cellular network 16a or a Wi-Fi network 16b.

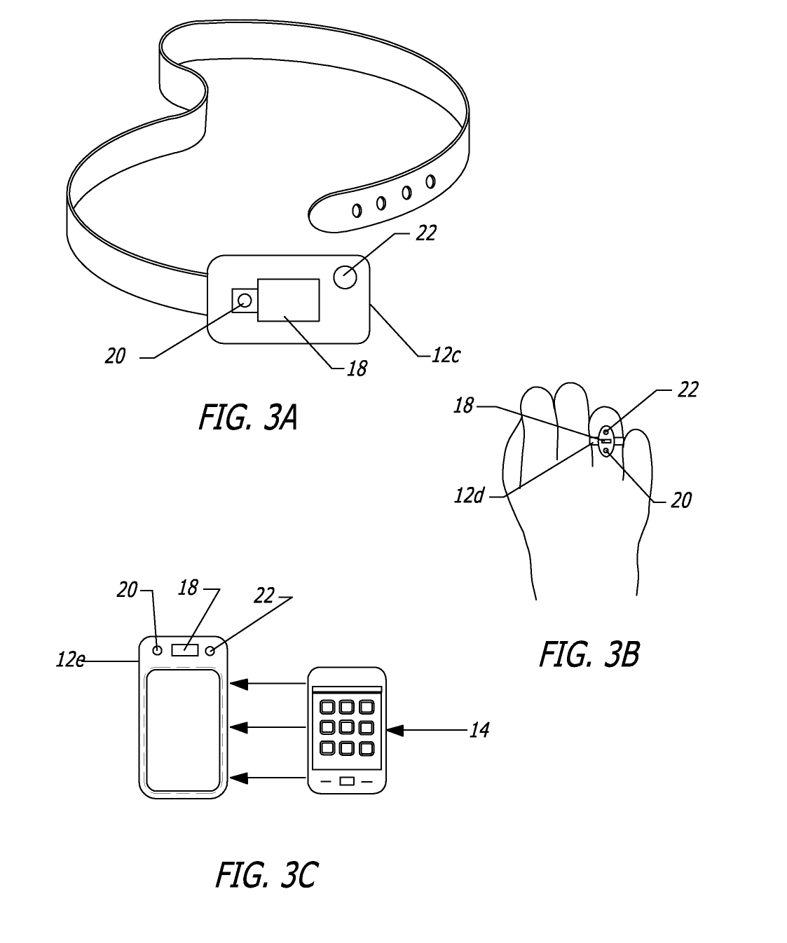

The mobile user device 12 preferably includes a programmable button 18 along with a microphone 20 and a speaker 22. The mobile user device 12 includes an integrated circuit (not shown) or similar computing device connected to the button 18, microphone 20 and speaker 22. The device 12 also includes a battery (not shown) or similar electrical source. The device 12 can be in a form other than a necklace or bracelet. Without limiting the form of the device 12, it may come in the form of a type of jewelry, a belt buckle 12c, a ring 12d, or other article commonly worn on a person's body or clothing as shown in FIGS. 3A and 3B. The device 12 may also be built into a case or container 12e for a phone 14 as shown in FIG. 3C. For example, a phone case 12e may be slightly oversized and contain all of the components of the device 12. In addition, the device 12 can be built into the phone itself such that an additional button is added to the phone housing or an existing button is programmed with functionality as described herein. When incorporated into the phone, the device would use the microphone 20 and speaker 22 already included in the phone 14.

The programmable button 18 is configured to activate the device 12 and create a wireless connection 24 between the device 12 and the phone 14. The button 18 preferably includes a cover or other safety feature (not shown) so as to prevent accidental bumping or activation. The wireless connection 24 may comprise a radio frequency signal, a Wi-Fi signal, or a Bluetooth signal as is commonly known in the industry for cellular phones.

Once this wireless connection 24 is established the device 12 would cause the system 10 to automatically dial an emergency service provider, i.e., 911, as it would have been preprogrammed. Once the emergency service is connected, the user can communicate through the microphone 20 and receive responses through the speaker 22. This communication would work similar to a Bluetooth or other wireless ear device as is commonly available for use with cellular phones 14. A user may then request whatever services are required to address the present emergency situation.

The button 18 may be programmed to respond differently based on how long it is depressed. For example, depressing the button for one second or less may automatically connect to an emergency service like 911. Depressing the button for at least three seconds may contact a preprogrammed number such as a personal emergency contact or family member. Depressing the button for five seconds or more may contact a doctor or non-emergency medical provider. Other contacts may be programmed as desired. Similar functionality may be programmed based on the number of times the button 18 is pressed.

The device 12 may include an audible alert or beep from the speaker 22 to let the user know how long the button has been depressed. For example, a single beep may indicate that emergency services are being called. A double beep may indicate that an emergency contact or family member is being called. A triple beep may indicate a non-emergency medical provider or physician is being called.

The device 12 is programmed to interact specifically with the phone 14 so as to automatically activate the cell phone, i.e., wakeup from sleep or hibernation mode, and bypass any password protection or other security feature to place the desired calls. In the case of a smart phone 14, the device 12 may be programmed to interact with its operating system, i.e., Android, iOS, Windows, etc. Most cell phones today are already programmed to permit emergency calls to 911 while bypassing such security features. In addition, certain phones are programmed to permit calls to numbers programmed in a contacts list through a linked Bluetooth or similar device while the phone 14 is locked. Such functionality can be implemented by the system 10.

In addition, a smart phone 14 may include a downloaded application (“app”) that is programmed to call certain programmed telephone numbers as described above. The app may have entries for different numbers to call depending upon the number of times or duration of time that the button 18 is depressed. Furthermore, the app may be programmed with certain medical information about the user that may be passed on when certain services are used. The app may communicate medical history information about the user or recent vital statistics, i.e., height, weight, blood pressure, pulse, etc. as may be recorded and entered into the app from time to time.

The application may also be programmed to interact with the specific mobile platform operating system, i.e., Android, iOS, Windows, etc., so as to facilitate waking of the phone when it is asleep and access of the app around password protection or other security features on the smart phone 14. The app may be programmed with different emergency, family member and/or non-emergency contacts as is desired. In addition, the app may be programmed to interact with an existing contacts list as exists on the phone for normal telephone use. The medical history information that is provided through the app may also include identifying information for the patient such as name, telephone number, social security number, emergency contacts, preferred hospital, doctor's name, allergies, etc.

The app may also include an alarm so that if the user has a stroke or other serious medical emergency and the user has enough time to depress the button 18, the alarm would activate and automatically call 911 and any other emergency contacts. The 911 operator or other emergency contact would be automatically connected and immediately start talking to the user. The app preferably can access the GPS system in the phone 14 so as to geolocate the user and provide that location to emergency service providers in the event the user is unable to speak or otherwise identify his or her location.

In the event the user has a bracelet 12b, such can be configured to automatically detect vital statistics from the wearer by one or more sensors 26. These vital statistics may include pulse, temperature, blood oxygen, blood pressure and/or any other easily measurable vital statistics. Such vital statistics can then be communicated to the emergency service provider by the app. The app can also be programmed to automatically call emergency services if such vital statistics, detected in real time, indicate a medical emergency. Certain thresholds may be established for such vital statistics that if the measured values exceed those preset thresholds for a given period of time a connection is automatically established.

Although several embodiments have been described in detail for purposes of illustration, various modifications may be made without departing from the scope and spirit of the invention. Accordingly, the invention is not to be limited, except as by the appended claims.

What is claimed is:

1. A wireless mobile emergency system configured to operate with a cellular device wirelessly connected to a communication network, comprising:
a mobile user alert device having an activation button for establishing a wireless connection with the cellular device;
wherein the mobile user alert device is programmed activate the cellular device to establish a telephone connection with an emergency contact through the communication network when the activation button is depressed; and
wherein the mobile user alert device has a microphone and speaker for receiving and broadcasting voice components of the telephone connection with the emergency contact.

2. The wireless mobile emergency system of claim 1, wherein the cellular device comprises a basic cell phone, a feature phone, or a smartphone.

3. The wireless mobile emergency system of claim 1, wherein the communication network comprises a cellular network or a Wi-Fi network.

4. The wireless mobile emergency system of claim 1, wherein the mobile user alert device comprises a necklace, a bracelet, a belt buckle, a ring, a piece of jewelry, or a phone case.

5. The wireless mobile emergency system of claim 1, wherein the wireless connection between the mobile user alert device and the cellular device comprises a radio frequency, Wi-Fi, or Bluetooth connection.

6. The wireless mobile emergency system of claim 1, wherein the mobile user alert device is programmed to activate the cellular device to establish a telephone connection with at least one of a plurality of emergency contacts depending upon a number of times or a duration of time that the activation button is depressed.

7. The wireless mobile emergency system of claim 6, wherein the plurality of emergency contacts include: emergency services; an emergency contact or family member; and/or a non-emergency provider.

8. The wireless mobile emergency system of claim 6, wherein the mobile user alert device issues an audible alert corresponding to the number of times or the duration of time that the activation button is depressed.

9. The wireless mobile emergency system of claim 6, wherein the cellular device comprises a smartphone and the system further comprises a software application on the smartphone, programmable with phone numbers for each of the plurality of emergency contacts.

10. The wireless mobile emergency system of claim 9, wherein the software application is programmable with medical information of a user and is configured to transmit the medical information to at least one of the plurality of emergency contacts.

11. The wireless mobile emergency system of claim 10, wherein the mobile user alert device comprises a bracelet including sensors for measuring vital statistics of the user in real-time, and the software application is configured to add the vital statistics to the medical information.

12. The wireless mobile emergency system of claim 11, wherein the system automatically establishes a telephone connection with emergency services if the vital statistics exceed preset thresholds in the software application.

13. The wireless mobile emergency system of claim 12, wherein the software application is configured to access GPS geo-location services on the smartphone and automatically transmit a location of the user to emergency services.
